(19) United States
(12) Patent Application Publication
(10) Pub. No.: US 2025/0135748 A1
(43) Pub. Date: May 1, 2025

(54) SURFACING MATERIAL

(71) Applicant: HEXCEL COMPOSITES LIMITED, Duxford (GB)

(72) Inventors: Ben TIPLER, Withersfield (GB); Mark WHITER, Saffron Walden (GB)

(73) Assignee: HEXCEL COMPOSITES LIMITED, Duxford (GB)

(21) Appl. No.: 18/686,634

(22) PCT Filed: Sep. 5, 2022
(86) PCT No.: PCT/GB2022/052255

§ 371 Date: Feb. 26, 2024

(30) Foreign Application Priority Data
Sep. 17, 2021 (GB) 2113314.5

(51) Int. Cl. B32B 7/025; B32B 5/02; B32B 15/02; B32B 15/14; B32B 15/20; B32B 27/08; B32B 27/12; B32B 27/38; B32B 27/40

(52) U.S. Cl. CPC B32B 7/025; B32B 5/022; B32B 15/02; B32B 15/14; B32B 15/20; B32B 27/08; B32B 27/12; B32B 27/38; B32B 27/40; B32B 2262/101; B32B 2307/202; B32B 2307/718; B32B 2307/724; B32B 2307/7376

(57) ABSTRACT

There is provided a surfacing material comprising an ultraviolet (UV) resistant polymer layer, a thermocurable or thermoplastic resin layer and a fibrous support, wherein a first surface of the UV resistant polymer layer forms an outermost surface of the surfacing material and the second surface of the UV resistant polymer layer contacts a first surface of the thermocurable or thermoplastic resin layer, and the second surface of the thermocurable or thermoplastic resin layer contacts a first surface of the fibrous support. There is also provided methods of forming cured composite structures having an ultraviolet resistant outer surface utilising a surfacing material of the invention, and cured composite structures incorporating a UV resistant surfacing layer of the invention.

The present invention relates to surfacing materials that provide a surface finish for composite structures without the need for post-curing treatments such as gel coat removal, sanding and painting, as well as methods of forming cured composite structures using the surfacing materials and cured composite structures produced using the surfacing materials. The present invention particularly relates to surfacing materials that provide an environmentally protective surface to cured composite structures without the need for painting, especially, but not exclusively, for use in the aerospace and wind turbine industries.

Composite materials have well-documented advantages over traditional construction materials, particularly in providing excellent mechanical properties at very low material densities. As a result, the use of such composite materials has become widespread in many industries, including the aerospace, automotive, marine and wind turbine industries.

Prepregs, comprising a fibre arrangement impregnated with a thermoplastic or thermocurable resin, such as epoxy resin, are widely used in the manufacture of composite structures. Typically, a number of plies of prepregs are “laid-up” as desired and the resulting assembly, or laminate, is placed in a mould and cured, usually by exposure to elevated temperatures, optionally under pressure, to produce a cured composite laminate. In an alternative manufacturing technique, a fibrous material is laid up, generally within an enclosure into which a liquid resin system can be infused to envelope the fibrous material, where it may then be cured to produce the finished article. The enclosure may be complete around the fibrous material, and the resin drawn in under vacuum (sometimes known as the vacuum bag technique). Alternatively, the enclosure may be a mould, and the resin may be injected into the mould (sometimes known as Resin Transfer Moulding), which may also be vacuum assisted (known as Vacuum Assisted Resin Transfer Moulding). As with the earlier described system in relation to prepregs, the liquid resin system may be a thermoplastic or thermocurable resin, such as an epoxy resin, a cyanate ester resin or a bismaleimide resin, and it may also contain a curative for the particular resin. Where composite structures are formed in moulds, it is commonly necessary to include a mould release agent on the mould surface to aid removal of the cured material from the mould. Generally, at least a portion of any such mould release agents will remain on the surface of the cured composite material after removal from the mould. The application of a mould release agent before laying up of composite materials prior to curing is an additional step in the production process, increasing production time and therefore cost, and the cost of the mould release agent lost in the process is an additional expense in the manufacturing process.

Composite surfaces are subject to weathering, including rain erosion, as well as other environmental damage, such as ultra-violet degradation of the resin, which can be a particular problem when the composite material is formed from more UV sensitive resins, such as epoxy resins. To protect the underlying plies, it is common practice to apply a UV protective paint to the outer surface of a composite material after curing. However, it is generally necessary to process a cured composite to render it suitable for painting, and this process typically requires some form of preparation of the surface, such as sanding/surface abrasion and cleaning, to remove any mould release agent on the surface and to key the surface prior to painting. The removal of the mould release agent is required to enable the paint to wet out the laminate surface and stop the formation of defects such as “orange peel”, paint runs, “fisheyes” and others. The time taken to remove the mould release agent is an additional step in the production process, again increasing production time and cost.

Painting can also result in uneven and variable coverage of the surface, especially if conducted by hand, leading to fluctuations in part weight and performance. Again, the time taken to prepare the surface for painting and the time taken for the painting itself, adds time and therefore cost to the production process. The cost of the paint is also an additional cost in the manufacturing process.

Various approaches have been taken to producing composite materials without the need for a mould release agent removal step. For example,
US2020/0316823 discloses a surfacing material that is intended to be capable of UV protection and self-releasing from a mould surface, and which is applied to the mould before composite layers are laid up and cured. The surfacing material is a multilayer structure composed of a curable resin layer laminated to a self-releasing layer/UV blocking layer, and is designed to be co-cured with the composite substrate. After co-curing the surfacing material is easily removed from the mould and functions as a temporary UV protective layer. However, this material does not form a permanent part of the cured composite material, and has to be removed from the cured composite material after curing, followed by painting of the revealed surface. Thus, using this surfacing material still requires a painting step, and this painting step as well as the surface layer removal step both add to the manufacturing time and cost. In addition, as the surfacing material is discarded after use, the cost of this material and the cost of the paint both represent additional costs in the manufacturing process.

The self-releasing/UV blocking layer of the surfacing materials described in US2020/0316823 is a thermoplastic polymer layer coated on one or both sides with a mould-release coating made of a fluoropolymer or an organosilicon polymer. When the mould-release coating is only on one side of the thermoplastic polymer layer, the coating is the outermost layer, i.e. the layer intended to contact a mould surface. The surfacing material may also include a non-removable textile carrier laminated to the side of the curable resin that is not in contact with the self-releasing/UV blocking layer, although no details of the textile layer are provided. Furthermore, as the textile layer is intended to remain attached to the cured composite structure after removal of the self-releasing/UV blocking layer, in embodiments of the surfacing materials in which a textile layer is included the self-releasing/UV blocking layer must include a mould-release layer on both sides, i.e. on the side that contacts the curable resin layer as well as the outermost layer that contacts the mould surface, to ensure separation of the UV blocking layer from the textile carrier after curing. Thus, in the materials of US2020/0316823, the thermoplastic polymer layer will not be in contact with the curable resin layer when a textile carrier is included in the surfacing material.

US2014/0011414 discloses a composite laminate for use on an external part of an aerospace vehicle that is said to provide improved ultraviolet resistance and resistance to microcracking from thermal cycling. The laminate comprises a nanoreinforcement film, a support veil, and a composite layer, and optionally also external paint and primer layers. The laminate may also include a lightning strike protection layer. The nanoreinforcement film comprises carbon nanomaterial, such as carbon nanofibers and nanotubes, mixed with a polymer resin, and the composite layer has one or more layers of a reinforcement and a polymer resin. Although the nanoreinforcement film is said to provide improved ultraviolet resistance, the resin component of the film is not completely covered at the surface and is still vulnerable to UV degradation, as well as other forms of environmental damage such as weathering, and the effects of this are simply masked to some, limited, degree by the other components of the film. Thus, in practice, the composite laminates of US2014/0011414 still require the incorporation of external paint and primer layers, either at assembly or subsequent to curing. Thus, the use of these materials does not remove the need for paint and primer materials, and may not avoid the need for post-curing processing steps such as surface preparation and painting.

The present invention aims to obviate or at least mitigate the above described problems and/or to provide improvements generally.

According to the invention there is provided a surfacing material comprising an ultraviolet (UV) resistant polymer layer, a thermocurable or thermoplastic resin layer and a fibrous support, wherein a first surface of the UV resistant polymer layer forms an outermost surface of the surfacing material and the second surface of the UV resistant polymer layer contacts a first surface of the thermocurable or thermoplastic resin layer, and the second surface of the thermocurable or thermoplastic resin layer contacts a first surface of the fibrous support.

The present invention also provides a method of forming a cured composite structure having an ultraviolet resistant outer surface utilising a surfacing material according to the present invention.

The present invention further provides a cured composite structure obtainable by the method of the present invention, and a cured composite structure having an ultraviolet resistant outer surface comprising an ultraviolet (UV) resistant polymer layer, wherein a first surface of the UV resistant polymer layer forms an outermost layer of the cured composite structure, and the second surface of the UV resistant layer is fused to a fibrous support, the fibrous support being infused with a cured thermoforming or thermoplastic resin, the cured composite structure further comprising at least one layer of fibrous reinforcement infused with a cured thermoformable or thermoplastic resin.

The surfacing materials of the present invention enable the manufacture of cured composite materials in a mould without the use of a mould release agent, as the UV resistant outer layer does not significantly bind to the mould surface. This provides a direct saving in the cost of mould release agents, and also saves significant time in the manufacturing process, firstly by avoiding the need for a step of applying a mould release agent to the mould before the laying up process, and also by avoiding the need for removal of the mould release agent after removal of the cured composite material from the mould. This saving in time also represents a reduction in the cost of the manufacturing process.

The surfacing materials of the present invention also enable the manufacture of cured composite materials that are ready for use without the need for the application of a protective outer layer after curing, such as by painting. This again results in a direct saving of material costs, because no paint is required, but also reduces the processing steps in the manufacturing process, for example by removing the need for a painting step and also reducing or completely eliminating the time normally required for post curing processing of the composite, such as sanding/keying the surface in preparation for painting. Again, this reduction in processing steps also results in a reduction in the cost of the manufacturing process.

Thus, the surfacing materials of the present invention substantially reduce the time and cost of preparing cured composite materials and structures. The processes of the present invention are therefore shorter and considerably less expensive than conventional composite manufacturing processes, and composite materials/structures produced by use of the materials of the invention and in the processes of the invention are less expensive than conventionally produced materials and result in the production of less waste material (used mould release agents, sanded surface layers, etc.).

The UV resistant polymer layer used in the surfacing materials of the present invention will form the outer layer of the cured composite materials produced by use of the surfacing material, and this layer should therefore preferably be robust enough to withstand the environmental challenges that the cured composite materials will encounter in day to day use, such as wind and rain. Preferably therefore, the UV resistant polymer layer has a Taber Abrasion resistance value of no more than 12 mg/500 cycles. The Taber Abrasion resistance of a material is measured according to ASTM D4060, and represents the amount of material removed over the stated number of cycles of abrasion under specified conditions (CS-10 wheels and 1000 g weight). Thus, a value of 12 mg/500 cycles means that 12 mg of material is removed after 500 cycles, under the above conditions, and the lower the measured value, the more robust/resistant to damage is the material. In preferred embodiments of the present invention, the UV resistant polymer layer has a Taber Abrasion resistance of no more than 6 mg/500 cycles, more preferably no more than 5 mg/500 cycles or even less, when tested under the specified conditions.

As the UV resistant polymer layer forms the outermost protective layer of the composite materials in which it is used, the layer is preferably a continuous layer, i.e., it preferably covers the entire surface of the surfacing material and has no significant gaps.

The UV resistant polymer layer is also preferably a flexible film, i.e., it is preferably sufficiently thin and flexible that the surfacing material may be handled easily and may be laid up on non-flat surfaces, such as a curved mould. In particular, the UV resistant polymer layers used in the present invention are flexible films at ambient conditions, i.e. they are flexible at the temperatures at which they are used in the surfacing materials of the present invention, particular at the temperatures under which the surfacing materials are formed and applied to mould surfaces, etc. The flexibility of a polymer film is generally related to the softening temperature of the polymer, i.e. the temperature at which the polymer film begins to harden or become brittle. Particularly suitable UV resistant polymer layer materials for use in the present invention therefore generally do not begin to harden or become brittle until the temperature is reduced to below 0° C., preferably below −10° C. and most preferable not until the temperature is reduced below −40° C. Thus, the UV resistant polymer layer used in the surfacing materials of the present invention preferably has a softening point below 0° C., preferably below −10° C., more preferably below −40° C. The softening point of polymer film material is generally available from the material supplier or from the literature, but if necessary, it may be determined by conventional means.

The UV resistant polymer layer of the surfacing material of the present invention is intended to remain as a permanent part of the composite material formed using the surfacing material, i.e. after curing the UV resistant polymer layer is non-removable under all generally encountered conditions or handling. It is therefore important that the UV layer forms a tight bond with the underlying fibrous support and the thermocurable or thermoplastic resin of the surfacing material after curing of the composite material in which the surfacing material is used. The ability to form a strong bond with the fibrous support/resin can generally be determined by the surface energy of the UV resistant layer. In particular, a higher surface energy enables the resin to wet out and adhere to the UV resistant layer during curing. Thus, in preferred embodiments of the present invention, the surface of the UV resistant polymer layer that contacts the thermocurable or thermoplastic resin layer in the uncured material has a surface energy of at least 30 dyn/cm, preferably at least 35 dyn/cm. In general, both surfaces of the UV resistant polymer layer will have the same surface energy, but where this is not the case, preferably at least the surface that contacts the thermocurable or thermoplastic resin layer has a surface energy of at least 30 dyn/cm.

The surface energy values of many UV resistant polymer layer materials are well known to those skilled in the art or can be found by reference to the material supplier. If required, the surface energy value of a material may be tested by a standard method using Dyne test pens, as set out in ISO 8296.

By “UV resistant” it is meant that the UV resistant polymer layer has a resistance to UV degradation/discoloration. A convenient method of measuring UV resistance is to measure the change in the Yellowness Index of a material under specific conditions. The Yellowness Index is calculated from spectrophotometric data that measures the appearance of the material on a scale from clear to white or yellow. A standard method of measuring the change in the Yellowness Index of a material is given in ASTM D-4329 cycle B using a QUV weatherometer fitted with UVA 340 bulbs (test conditions: a repeated cycle of 8 hours at 70° C. under UVA and 4 hours at 50° C. water condensation (no UVA) running for 2000 hours total). In preferred embodiments of the present invention, the change in the Yellowness Index of the UV resistant polymer layer under the specified test conditions is no more than 3.0, preferably no more than 2.0 under the above conditions.

Preferably, the UV resistant polymer layers used in the surfacing materials of the present invention also significantly reduce the transmission of UV light through the outer polymer layer, and thereby provide a protective effect for UV sensitive components below the outermost surface, such as epoxy resins in the surfacing material itself or in the underlying composite layers.

The UV resistant polymer layer used in the surfacing materials of the present invention may have any suitable thickness, but in preferred embodiments the UV resistant polymer layer has a thickness of from 5 to 500 μm, preferably from 25 to 250 μm.

The UV resistant polymer layer of the surfacing materials of the present invention may be formed from any suitable material, i.e., any material capable of forming an outer layer on a composite material and having resistance to UV degradation. Suitable materials will preferably be capable of forming a continuous film, more preferably a flexible continuous film, and the film will preferably have the durability, softening point, surface energy and Yellowness Index values discussed herein. The film will also preferably have a good resistance to UV transmission. Those skilled in the art will be able to identify suitable materials to form the UV resistant polymer layer, but such materials may include a thermoplastic film, preferably a polyurethane based thermoplastic film, such as a polycaprolactone-based aliphatic polyurethane film. Examples of suitable UV resistant polymer films include Argotec Thermoplastic Polyurethane (TPU) films, such as Argotec 46510-White, Argotec 46510-Clear and Argotec 49510, all available from Schweitzer-Mauduit International, Inc., Georgia, USA.

The thermocurable or thermoplastic resin layer used in the surfacing materials of the present invention attaches the second (inner) face of the UV resistant polymer layer to the fibrous support, and in the uncured state, i.e., before the surfacing material has been used to form a cured composite material, this attachment is not necessarily permanent, although it may be so in some embodiments. Thus, in the uncured state, the resin layer provides at least sufficient attachment for the UV resistant polymer layer and the fibrous support to be handled together, particularly so that the surfacing material may be conveniently laid down in a mould, but in some embodiments the degree of attachment before curing may be such that the UV resistant polymer layer can be separated if desired (such as by pulling apart).

Once the surfacing material of the present invention has been cured as part of the process of producing a cured composite material, the resin layer provides sufficient attachment that the UV protective polymer layer and the fibrous support cannot be separated under conditions normally encountered in day to day use of the composite material, i.e. the surfacing material becomes non-removable in day to day use. Thus, preferably, once a composite material has been produced using the surfacing material of the present invention, the thermocurable or thermoplastic resin layer provides sufficient adhesion that the UV resistant polymer layer is fused to the fibrous support with a pull-off strength of at least 4 MPa, preferably at least 5 MPa. The pull-off strength of the bond between the UV resistant polymer layer and the fibrous support can be measured using a standard method employing an Elcometer 506 Pull-Off Adhesion Tester, such as in ISO 4624 employing 20 mm dollies.

The thermocurable or thermoplastic resin layer may be a discontinuous layer, i.e. there may be gaps in the layer, so long as the resin layer covers enough of the surface of the UV resistant polymer layer to provide attachment to the fibrous support, but preferably, the resin layer is a continuous layer and covers the entire surface of the UV resistant polymer layer.

The thermocurable or thermoplastic resin layer may be a discreet separate layer between the UV resistant polymer layer and the fibrous support within the surfacing material of the present invention before the surfacing material has been cured, but alternatively, the thermocurable or thermoplastic resin layer may partially or wholly impregnate the fibrous support. In embodiments in which the thermocurable or thermoplastic resin layer partially or wholly impregnates the fibrous support, the surfacing material may be prepared by initially partially or wholly impregnating the fibrous support with the thermocurable or thermoplastic resin layer before applying the combined resin and support to the UV resistant polymer layer, and this may simplify the production process of the surfacing material.

Any amount of the thermocurable or thermoplastic resin may be used in the surfacing materials of the present invention, so long as there is sufficient resin to form a layer between the UV resistant polymer layer and the fibrous support and to provide sufficient attachment between the layers in both the uncured and cured states. The amount required will also depend to some extent on the degree of absorbency of the fibrous support and the presence of additional components in the surfacing material. In some embodiments of the present invention, the thermocurable or thermoplastic resin layer has an areal weight of from 3 g/m² to 500 g/m², such as from 25 g/m² to 200 g/m².

Alternatively, the amount of the thermocurable or thermoplastic resin in the surfacing material of the present invention may be expressed as the proportion of resin as a percentage of the combined weight of the UV resistant polymer layer, the resin layer and the fibrous support. Thus, in certain embodiments, the thermocurable or thermoplastic resin layer comprises from 2.5% to 90% by weight of the total weight of the UV resistant polymer later, the thermocurable or thermoplastic resin layer and the fibrous support.

Any thermocurable or thermoplastic resin may be used in the surfacing materials of the present invention, so long as the resin is compatible with the other components of the surfacing material and is capable of forming a strong bond between the UV resistant polymer layer and the fibrous support following formation of the cured composite material in which it is used. The thermocurable or thermoplastic resin may be a solid resin, a semi-solid resin or a liquid resin. Suitable resins include epoxy resins of the kinds well-known for use in forming composite materials. Epoxy resins have very useful properties in composite materials and surfacing materials but are relatively sensitive to UV damage, and they therefore particularly benefit from the UV resistant/UV blocking aspects of the present invention. Curing agents may also be present in the resin, if necessary to provide the required degree of adhesion in the finished cured composite material prepared from the surfacing material. An example of a suitable general resin for use in the present invention is a semisolid bisphenol A epoxy resin containing a latent curing agent, and a suitable commercially available material is an epoxy resin film such as Hexbond® 679, available from Hexcel Corporation, USA.

The fibrous support used in the surfacing materials of the present invention increases the robustness of the surfacing material and therefore its handleability. In addition, the fibrous support may improve the surface quality of cured composite materials produced using the surface materials of the invention as it prevents print-though of the underlying fibres of the composite layers showing at the surface. Preferably, therefore, the fibrous support is a substantially continuous layer and covers the entirety of the second surface of the UV resistant polymer layer.

In the context of the present invention, a fibrous support means any material formed from fibres which is robust enough to carry a layer of resin, to prevent print-through of underlying fibrous layers after formation of a cured composite, and which is also able to withstand processing in the processes of the invention. The fibrous support is also preferably both air and resin permeable.

Particularly suitable fibrous supports for use in the surfacing material of the present invention are non-woven materials.

The fibrous support used in the surfacing materials of the present invention may be formed from any suitable fibre materials such as glass, carbon, polyester, polyamide, aramid (aromatic polyamide), or combinations thereof. The fibres may be joined in any particular way, such as by bonding using a binding agent or thermal bonding, or by physical means such as by needle punching. A particularly suitable fibrous support is a non-woven material comprising a glass fleece and an organic binder. In a particular embodiment the non-woven glass fleece comprises an organic binder in an amount of 1 to 10% by weight based on the total weight of the fibrous support. An example of a suitable fibrous support for use in the present invention is Evalith® S5030, available from Johns Manville, USA.

The fibrous support may be any weight or thickness as long as it is structurally capable of supporting a resin film and preventing print-through of underlying fibrous layers, but in a preferred embodiment the fibrous support has an areal density of at least 10 g/m² and no more than 300 g/m², preferably an areal density of from 25 g/m² to 200 g/m².

The fibrous support used in the surfacing materials of the present invention is preferably both air and resin permeable, to permit the thermocurable or thermoplastic resin to impregnate the fibrous support and to prevent air being trapped in the layers of the surfacing material during processing. Preferably, the fibrous support has an air permeability of from 1000 l/m²s to 7000 l/m²s, preferably from 2000 l/m²s to 6000 l/m²s. The air permeability may be measured by any suitable method, such as using DIN EN ISO 9237.

The surfacing materials of the present invention may comprise further components in addition to the UV resistant polymer layer, thermocurable or thermoplastic resin layer and fibrous support. Particularly useful additional components are components that would normally be included in the lay-up of a composite material, so that by incorporating such components in the surfacing materials in advance, the step of adding such components during the laying up process can be avoided, further increasing the amount of time saved by using the surfacing materials of the invention.

An example of a particularly useful additional component that may be included in the surfacing materials of the present invention is a lightning strike protective component. Lightning strike protective components for composite materials are well known, and suitable components generally comprise an electrically conductive layer. Any known lightning strike protective component may be used in the present invention, but electrically conductive layers are particularly suitable for incorporation in the surfacing materials, and in order to reduce the weight/bulk of the materials, electrically conductive metal meshes are particularly preferred. When incorporated in the surfacing materials of the present invention, lightning strike components will preferably be positioned next to the second surface of the fibrous support, i.e. the surface that is not in contact with the thermocurable or thermoplastic resin layer/UV resistant polymer layer. Where present, the electrically conductive layer may be separated from the fibrous support by one or more additional components, but preferably the electrically conductive layer is effectively directly in contact with the fibrous support or attached to the fibrous support by the thermocurable or thermoplastic resin that has passed fully through the fibrous support.

Alternative or additional further components that may be included in the surfacing materials of the present invention include one or more layers of fibrous reinforcement, such as layers of fibrous reinforcement used to form composite materials. Any conventional layers of fibrous material may be used in the surfacing materials of the present invention, such as glass, carbon, aramid or any other structural fibres, depending on the intended use of the surfacing materials. Where present, the fibrous reinforcement may be dry fibres (which may be attached to the surfacing material in any conventional manner, such as by stitching), or they may be partially or fully impregnated with a thermocurable or thermoplastic resin. Where present, the thermocurable or thermoplastic resin may be the same resin as the resin used to join the UV resistant polymer layer to the fibrous support or it may be a different resin. When incorporated in the surfacing materials of the present invention, the one or more layers of fibrous reinforcement will preferably be nearest to the second surface of the fibrous support, i.e. the surface that is not in contact with the thermocurable or thermoplastic resin layer/UV resistant polymer layer. Where present, the one or more layers of fibrous reinforcement may be directly in contact with the fibrous support or attached to the fibrous support by the thermocurable or thermoplastic resin that has passed fully through the fibrous support, or it may be separated from the fibrous support by one or more additional components. For example, where the surfacing materials of the present invention comprise both a lightning strike protective component and one or more layers of fibrous reinforcement, the lightning strike protective component is preferably located directly in contact with the second surface of the fibrous support, and the one or more layers of fibrous reinforcement is in contact with the side of the lightning strike protective component that is not in contact with the fibrous support. All of these layers may be joined by the same or different thermocurable or thermoplastic resins, or some of the layers may be joined by physical means, such as stitching.

The surfacing materials of the present invention may be prepared by conventional methods for preparing surfacing materials. For example, a layer of thermocurable or thermoplastic resin may be applied to a fibrous support and, optionally, partially impregnated into the fibrous support, and a layer of UV resistant polymer may then be applied to the surface of the resin to thereby become joined to the fibrous support. Additional components, such as lightning strike protective components and/or layers of fibrous reinforcement, may be added to the surfacing material during the process of attaching the UV resistant polymer layer to the fibrous support, or before or after this step.

The surfacing materials of the present invention may be used to form cured composite structures as set out herein.

In a first embodiment, the method of preparing cured composite structures of the present invention comprises:
a) depositing a surfacing material according to the present invention on the surface of a mould or tool with the outermost surface of the surfacing material comprising the first surface of the UV resistant polymer layer in contact with the mould or tool surface;
b) depositing one or more layers of fibrous reinforcement onto the surface of the surfacing material remote from the mould or tool surface, at least one of the layers of fibrous reinforcement comprising an associated layer of thermocurable or thermoplastic resin; and
c) co-curing the surfacing material and the thermocurable or thermoplastic resin of the one or more layers of fibrous reinforcement so as to form a cured composite structure.

In a second embodiment, the method of preparing cured composite structures of the present invention comprises:
a) depositing a surfacing material according to the present invention on the surface a mould or tool with the outermost surface of the surfacing material comprising the first surface of the UV resistant polymer layer in contact with the mould or tool surface;
b) depositing one or more layers of fibrous reinforcement on to the surface of the surfacing material remote from the mould or tool surface;
c) infusing the surfacing material and the one or more layers of fibrous reinforcement with a thermocurable or thermoplastic resin to form a resin infused stack of fibrous reinforcement; and
d) co-curing the surfacing material and the thermocurable or thermoplastic resin of the resin infused stack of fibrous reinforcement so as to form a cured composite structure.

During the process of forming the cured composite structures, the surfacing material of the invention is deposited on the surface of a mould or tool so that the first surface of the UV resistant polymer layer is in contract with the surface of the mould or tool, and it will generally not be necessary to apply mould release agents to the surface of the mould or tool before the surfacing material is deposited.

Once the surfacing material of the invention has been deposited on the surface of the mould or tool, one or more layers of fibrous reinforcement are deposited on to the surfacing material in a conventional manner. The fibrous reinforcement layers can be any materials used in the preparation of composite materials, and the particular materials used will depend on the intended use of the cured composite material. The fibrous reinforcement layers may be dry layers, or they may comprise one or more thermocurable or thermoplastic resins, which may be partially or fully impregnated into the fibrous reinforcement before being deposited, i.e., the materials used may be dry fibres, semi-preg or prepreg materials. The resin incorporated in the semi-preg or prepreg layers used in the process of the invention may be the same resin as is present in the surfacing material of the invention or it may be one or more different resins. Epoxy resins are particularly suitable for use in forming many cured composite structures, and are particularly suitable for use in the processes of the present invention, because the UV resistant polymer layer of the surfacing material will protect the epoxy resin of the underlying composite structure from degradation by UV light without the need for a UV protective paint to be applied to the cured composite structure.

The methods used to infuse the surfacing materials and underlying structural layers in the process of the present invention, and the methods used to co-cure the surfacing materials and underlying layers of fibrous reinforcement and thermoformable or thermoplastic resin will be any suitable methods used in the preparation of cured composite materials.

The cured composite structures of the present invention have an ultraviolet resistant outer surface comprising an ultraviolet (UV) resistant polymer layer, wherein a first surface of the UV resistant polymer layer forms an outermost layer of the cured composite structure, and the second surface of the UV resistant layer is fused to a fibrous support, the fibrous support being infused with a cured thermoforming or thermoplastic resin, and the cured composite structure further comprising at least one layer of fibrous reinforcement infused with a cured thermoformable or thermoplastic resin; and it will be understood that the components of the surface layer of the cured composite structures of the present invention correspond to the components of the surfacing materials of the present invention, as discussed herein, taking into account the fact that the composite structures have been cured, i.e., the components of the surface layers of the cured composite structures comprise cured materials corresponding to the uncured materials of the surfacing materials of the present invention.

In particular embodiments of the cured composite structures of the present invention, the UV resistant polymer layer is fused to the fibrous support with a pull-off strength of at least 4 MPa, preferably at least 5 MPa, as measured as described herein.

In particular embodiments of the cured composite structures of the present invention, the UV resistant polymer layer has a Taber abrasion resistance value of no more than 12 mg/500 cycles, preferably no more than 6 mg/500 cycles, when measured as described herein.

The invention will now be described by way of example only and with reference to the accompanying drawings in which;

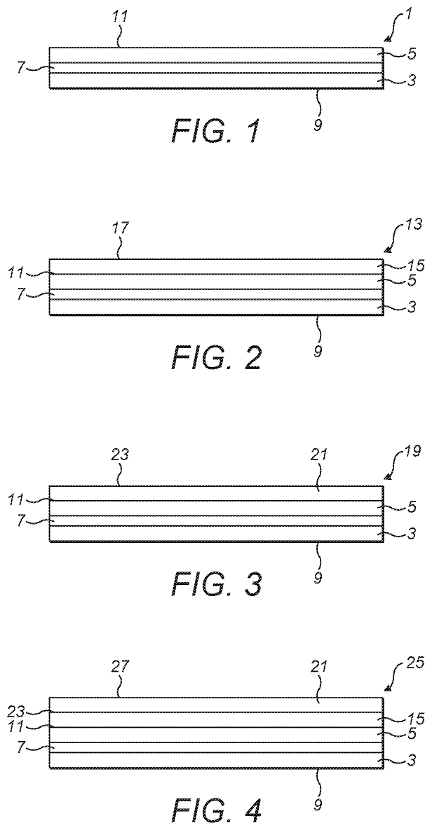

FIG. 1 is a diagrammatic view of a surfacing material according to a first embodiment of the present invention,

FIG. 2 is a diagrammatic view of a surfacing material according to a second embodiment of the present invention,

FIG. 3 is a diagrammatic view of a surfacing material according to a third embodiment of the present invention, and

FIG. 4 is a diagrammatic view of a surfacing material according to a fourth embodiment of the present invention.

FIG. 1 shows a representation of a surfacing material 1 in accordance with a first embodiment of the present invention. The surfacing material 1 comprises an ultraviolet resistant polymer layer 3 attached to a fibrous support 5 by a thermocurable or thermoplastic resin layer 7. It should be noted that the various layers are not shown to scale. The thermocurable or thermoplastic resin layer 7 may be a separate layer or may partially or fully impregnate the fibrous support 5 so long as there is sufficient resin available at the surface of the fibrous support 5 to attach the fibrous support 5 to the UV resistant polymer layer 3 and to form a strong, effectively inseparable bond between the fibrous support 5 and the UV resistant layer 3 after curing of the surfacing material. The surfacing material 1 has an outermost surface 9 provided by the surface of the UV resistant polymer layer 3 that is not in contact with the thermocurable or thermoplastic resin layer 7. The surfacing material 1 also has an inner surface 11, provided by the surface of the fibrous support 5 which is not in contact with the thermocurable or thermoplastic resin layer 7.

FIG. 2 shows a representation of a surfacing material 13 in accordance with a second embodiment of the present invention. The surfacing material 13 comprises an ultraviolet resistant polymer layer 3 attached to a fibrous support 5 by a thermocurable or thermoplastic resin layer 7, as in the surfacing material 1 of FIG. 1, but also includes a lightning strike protective component 15 attached to the surface 11 of the fibrous support 5 that is not in contact with the thermocurable or thermoplastic resin layer 7. The surfacing material 13 has an outermost surface 9 provided by the surface of the UV resistant polymer layer 3 that is not in contact with the thermocurable or thermoplastic resin layer 7. The surfacing material 13 also has an inner surface 17, provided by the surface of the lightning strike protective component 15 which is not in contact with the fibrous support 5.

FIG. 3 shows a representation of a surfacing material 19 in accordance with a third embodiment of the present invention. The surfacing material 19 comprises an ultraviolet resistant polymer layer 3 attached to a fibrous support 5 by a thermocurable or thermoplastic resin layer 7, as in the surfacing material 1 shown in FIG. 1, but also includes a layer of fibrous reinforcement 21 attached to the surface 11 of the fibrous support 5 that is not in contact with the thermocurable or thermoplastic resin layer 7. The surfacing material 19 has an outermost surface 9 provided by the surface of the UV resistant polymer layer 3 that is not in contact with the thermocurable or thermoplastic resin layer 7. The surfacing material 19 also has an inner surface 23, provided by the surface of the fibrous reinforcement 21 which is not in contact with the fibrous support 5.

FIG. 4 shows a representation of a surfacing material 25 in accordance with a fourth embodiment of the present invention. The surfacing material 25 comprises an ultraviolet resistant polymer layer 3 attached to a fibrous support 5 by a thermocurable or thermoplastic resin layer 7, as in the surfacing material 1 of FIG. 1, but also includes a lightning strike protective component 15 attached to the surface 11 of the fibrous support 5 that is not in contact with the thermocurable or thermoplastic resin layer 7. In addition, the surfacing material 25 also includes a layer of fibrous reinforcement 21 attached to the surface 23 of the lightning strike protective component 15 that is not in contact with the fibrous support 5. The surfacing material 25 has an outermost surface 9 provided by the surface of the UV resistant polymer layer 3 that is not in contact with the thermocurable or thermoplastic resin layer 7. The surfacing material 25 also has an inner surface 27, provided by the surface of the fibrous reinforcement 21 which is not in contact with the lightning strike protective component 15.

### EXAMPLES

### Example 1

A surfacing material 1 was produced having the structure shown in FIG. 1. The UV resistant polymer layer 3 was a layer of Argotec 46510-Clear polyurethane resin (available from Schweitzer-Mauduit International, Inc., Georgia, USA) having a thickness of 0.2 mm. The fibrous support 5 was an Evalith® S 5030 non-woven glass mat (available from Johns Manville, USA) partially impregnated with 50% w/w Hexbond® 679 epoxy resin (available from Hexcel Corporation, USA). The resin layer 7 was positioned between the fibrous support 5 and the UV resistant polymer layer 3 to attach the UV resistant polymer layer 3 to the fibrous support 5.

In use, the outer surface 9 of the UV resistant polymer layer 3 of the surfacing material 1 is placed in contact with the untreated surface of a mould or tool, and additional layers required to form a composite material are laid up on top of the surfacing material 1, the first additional layer being placed on the surface 11 of the fibrous support 5 that is not in contact with the thermocurable or thermoplastic resin layer 7. The additional layers placed on the surfacing material 1 may include any conventional layers, such as one or more layers of impregnated or unimpregnated fibrous reinforcement, lightning strike protective components, etc. An example of a suitable layer of impregnated fibrous reinforcement is a layer of Hexply® M79-LT/43%/LBB1200 partially or fully impregnated glass fibre reinforcement (available from Hexcel Corporation, USA). An example of a suitable layer of unimpregnated fibrous reinforcement is a layer of G-Ply LBB1200 glass fibre reinforcement, available from Chomarat, France.

Once sufficient additional layers have been laid up on top of the surfacing material 1 the lay-up may be cured by any suitable means. After curing the resultant cured composite may be easily removed from the mould or tool surface and will be suitable for immediate use, i.e. without the need for post curing treatments such as sanding or painting.

### Example 2

A second surfacing material 1 was produced having the structure shown in FIG. 1. The UV resistant polymer layer 3 was a layer of Argotec 46510-White polyurethane resin (available from Schweitzer-Mauduit International, Inc., Georgia, USA) having a thickness of 0.05 mm. The fibrous support 5 was an Evalith® S 5030 non-woven glass mat (available from Johns Manville, USA) fully impregnated with 50% w/w Hexbond® 679 epoxy resin (available from Hexcel Corporation, USA). The resin layer 7 provided sufficient tack at the surface of the fibrous support 5 to connect the fibrous support 5 to the UV resistant polymer layer 3.

In use, the surfacing material 1 of Example 2 may be employed in the same manner as the surfacing material 1 of Example 1 and may be laid up with layers of dry and resin impregnated fibrous reinforcement in the same way and subsequently cured. Again, after curing the cured composite material may be easily removed from the mould or tool surface and will be ready for use without any post curing treatment such as sanding or painting.

### Example 3

A surfacing material 13 was produced having the structure shown in FIG. 2. The UV resistant polymer layer 3 was a layer of Argotec 46510 polyurethane resin (available from Schweitzer-Mauduit International, Inc., Georgia, USA) having a thickness of 0.2 mm, and the fibrous support 5 was an Evalith® S 5030 non-woven glass mat fully impregnated with 50% w/w Hexbond® 679 epoxy resin, with the resin layer 7 providing sufficient tack at the surface of the fibrous support 5 to connect the fibrous support 5 to the UV resistant polymer layer 3. A lightning strike protective component 15 comprising an aluminium mesh, specifically a layer of Small, Expanded Metal, Flattened, Aluminium Mesh (217AF), available from The Expanded Metal Company, UK, was included in the surfacing material in contact with the surface of the fibrous support 5 that is not in contact with the resin layer 7.

In use, the outer surface 9 of the UV resistant polymer layer 3 of the surfacing material 13 is placed in contact with the untreated surface of a mould or tool, and additional layers required to form a composite material are laid up on top of the surfacing material 13, the first additional layer being placed on the surface 17 of the lightning strike protective component 15 that is not in contact with the fibrous support 5. The additional layers may include any suitable layers for forming a composite component, but it is not necessary to include a lightning strike component when carrying out the laying up, as this component is already provided as part of the surfacing material 13.

Once sufficient additional layers have been laid up on top of the surfacing material 13 the lay-up may be cured by any suitable means. After curing the resultant cured composite may be easily removed from the mould or tool surface and will be suitable for immediate use, i.e. without the need for post curing treatments such as sanding or painting.

### Example 4

A surfacing material 19 was produced having the structure shown in FIG. 3. The UV resistant polymer layer 3 was a layer of Argotec 49510 polyurethane resin having a thickness of 0.05 mm, and the fibrous support 5 was an Evalith® S 5030 non-woven glass mat partially impregnated with 50% w/w Hexbond® 679 epoxy resin, with the resin layer 7 positioned between the fibrous support 5 and the UV resistant polymer layer 3. In this example, a lightning strike protective client was not required by the end user, but the user required a layer of fibrous reinforcement to be included in the surface material. The layer of fibrous reinforcement 21 was an unimpregnated layer of G-Ply LBB1200 glass fibre reinforcement, but in an alternative embodiment a layer of Hexply® M79-LT/43%/LBB1200 partially or fully impregnated glass fibre reinforcement could be used. The layer of fibrous reinforcement 21 was included in the surfacing material 19 in contact with the surface of the fibrous support 5 not in contact with the resin layer 7.

In use, the outer surface 9 of the UV resistant polymer layer 3 of the surfacing material 19 is placed in contact with the untreated surface of a mould or tool, and additional layers required to form a composite material are laid up on top of the surfacing material 19, the first additional layer being placed on the surface 23 of the fibrous reinforcement layer 21 that is not in contact with the fibrous support 5. The additional layers may include any suitable layers for forming a composite component, but one less layer of fibrous reinforcement will be required than when a normal lay-up process is used, as a layer of fibrous reinforcement is already provided as part of the surfacing material 21.

Once sufficient additional layers have been laid up on top of the surfacing material 19 the lay-up may be cured by any suitable means. After curing the resultant cured composite may be easily removed from the mould or tool surface and will be suitable for immediate use, i.e. without the need for post curing treatments such as sanding or painting.

### Example 5

A surfacing material 25 was produced having the structure shown in FIG. 4. The UV resistant polymer layer 3 was a layer of Argotec 46510-White polyurethane resin (available from Schweitzer-Mauduit International, Inc., Georgia, USA) having a thickness of 0.2 mm, and the fibrous support 5 was an Evalith® S 5030 non-woven glass mat fully impregnated with 50% w/w Hexply® 679 epoxy resin, with the resin layer 7 providing sufficient tack at the surface of the fibrous support 5 to connect the fibrous support 5 to the UV resistant polymer layer 3. The lightning strike protective component 15 was an aluminium mesh, such as a layer of Small, Expanded Metal, Flattened, Aluminium Mesh (217AF). The layer of fibrous reinforcement 21 was a layer of Hexply® M79-LT/43%/LBB1200 partially or fully impregnated glass fibre reinforcement, but in an alternative embodiment a layer of unimpregnated G-Ply LBB1200 glass fibre reinforcement could be used. The lightning strike protective component 15 was placed in contact with the surface of the fibrous support 5 not in contact with the resin layer 7, and the layer of fibrous reinforcement 21 was placed in contact with the surface of the lightning strike protection component 15 not in contact with the fibrous support 5.

In use, the outer surface 9 of the UV resistant polymer layer 3 of the surfacing material 25 is placed in contact with the untreated surface of a mould or tool, and additional layers required to form a composite material are laid up on top of the surfacing material 25, the first additional layer being placed on the surface 27 of the fibrous reinforcement layer 21 that is not in contact with the lightning strike protective component 15. The additional layers may include any suitable layers for forming a composite component, but it is not necessary to include a lightning strike component when carrying out the laying up, as this component is already provided as part of the surfacing material 25, and also one less layer of fibrous reinforcement will be required than when a normal lay-up process is used, as a layer of fibrous reinforcement is already provided as part of the surfacing material 25.

Once sufficient additional layers have been laid up on top of the surfacing material 25 the lay-up may be cured by any suitable means. After curing the resultant cured composite may be easily removed from the mould or tool surface and will be suitable for immediate use, i.e. without the need for post curing treatments such as sanding or painting.

### Example 6

A cured composite structure according to the present invention was formed using a surfacing material according to Example 1 in combination with two layers of fibre-glass based prepreg cured at 95° C. for 4 hours. After curing, the surfacing film was not removable from the composite structure.

The Taber abrasion resistance of the UV resistant polymer surface of the cured composite structure was tested according to ASTM D4060 using CS-10 wheels and 1000 g, and 2 mg of material was removed after 500 cycles.

The change in the Yellowness Index of the surface layer of the cured material of Example 1 was also tested according to ASTM D-4329 cycle B, using a QUV weatherometer fitted with UVA 340 bulbs and test conditions comprising a repeated cycle of 8 hours at 70° C. under UVA and 4 hours at 50° C. water condensation (no UVA) for 2000 hours in total. The change was found to be less than 2.0 in 2000 hours.

### Example 7

A cured composite structure according to the present invention was formed using a surfacing material according to Example 2 in combination with two layers of fibre-glass based prepreg cured at 95° C. for 4 hours. After curing, the surfacing film was not removable from the composite structure.

The Taber abrasion resistance of the UV resistant polymer surface of the cured composite structure was tested according to ASTM D4060 using CS-10 wheels and 1000 g, and 5 mg of material was removed after 500 cycles.

The change in the Yellowness Index of the surface layer of the cured material of Example 2 was also tested according to ASTM D-4329 cycle B, using a QUV weatherometer fitted with UVA 340 bulbs and test conditions comprising a repeated cycle of 8 hours at 70° C. under UVA and 4 hours at 50° C. water condensation (no UVA) for 2000 hours in total. The change was found to be less than 1.5 in 2000 hours.

### Example 8

The effectiveness of the surfacing materials of the present invention may be demonstrated by comparing the process of preparing a cured component, such as a cured rotor blade for a wind energy generator using each of the surfacing materials of Examples 1 to 5 and two conventional “control” materials.

In the manufacturing process, for each of Examples 1 to 5, the surfacing materials 1, 13, 19 and 25 are laid up on an untreated mould, with the UV resistant polymer layer 3 in contact with the mould surface. For Examples 1 and 2 a lightning strike protective mesh is then applied to the surfacing material, but this stage can be omitted for the materials of Examples 3, 4 and 5. Multiple plies of resin impregnated and/or unimpregnated fibrous reinforcement are then laid up on top of the surfacing materials, but for the materials of Examples 4 and 5, one fewer layer is required (this can be envisioned as a first step of laying up a first ply, and a second step of laying up additional plies, wherein the first step can be omitted for the materials of Examples 4 and 5). The stacks of laid up plies are then prepared for curing using standard components (such as release foil, breather fabric and a vacuum bag for prepreg based stacks, and peel ply, infusion mesh, release foil and a vacuum bag for stacks intended for infusion) and subsequently infused and/or cured. The cured laminates are then removed from the mould and are ready for use. In particular, the cured laminates already comprise a non-removable UV resistant layer, and it is therefore not necessary to carry out any further preparation of the cured laminates such as sanding or painting.

In comparison, instead of the surfacing materials of the present invention, a conventional process could be carried out using a gel coat such as Crystic®Brush Polyester Gelcoat 252PA, available from Scott Bader Company Limited, UK (Control 1), or a non-woven semipreg surfacing material such as Hexply XF Surface Technology (available form Hexcel Corporation, USA) (Control 2). In each case, a mould release agent must firstly be applied to the surface of the mould and allowed to dry before the surfacing material is applied. In the case of Control 1, the gel coat must also be allowed to dry after application. The layup of layers then proceeds as in examples 1 to 5, including the addition of a lightning strike protective mesh and the full number of layers of fibrous reinforcement. The laid-up stacks of Controls 1 and 2 are then prepared for curing, cured and removed from the mould as in Examples 1 to 5, but in both cases the additional steps of removing adhered mould release agent and subsequent painting with a UV resistant paint must also be completed after the Control materials have been removed from the mould.

The relative time savings provided by the materials of Examples 1 to 5 compared to Control materials 1 and 2 are summarised in table 1 below.

TABLE 1
Relative times for typical rotor blade manufacture using various surfacing materials.

| Step | Example 1 & 2 | Example 3 | Example 4 | Example 5 | Control 1 | Control 2 |
|---|---|---|---|---|---|---|
| Apply mould release and dry 1 hour | X | X | X | X | ✓ | ✓ |
| Apply and cure gel coat 2 hours | X | X | X | X | ✓ | X |
| Add Lighting strike mesh 1 hour | ✓ | X | X | X | ✓ | ✓ |
| Layup first ply of laminate 1 hour | ✓ | ✓ | X | X | ✓ | ✓ |
| Lay-up rest of laminate | ✓ | ✓ | ✓ | ✓ | ✓ | ✓ |
| Cure laminate | ✓ | ✓ | ✓ | ✓ | ✓ | ✓ |
| De-mould | ✓ | ✓ | ✓ | ✓ | ✓ | ✓ |
| Prepare surface 1-7 hour | X | X | X | X | ✓ | ✓ |
| Paint 1 hour | X | X | X | X | ✓ | ✓ |
| Total times | 19-25 hours | 18-24 hours | 17-23 hours | 17-23 hours | 30 hours | 28 hours |
| Potential time saving [Hr] | 5-11 | 6-12 | 7-13 | 7-13 | 0 | 2 |

As may be seen from Table 1, very significant time savings may be achieved by use of the surfacing materials of the present invention, and these savings will lead to significant cost savings. In addition, the use of the surfacing materials of the present invention will also reduce the use of raw materials, such as mould release agents and paint.

1. A surfacing material comprising:
a) an ultraviolet (UV) resistant polymer layer;
b) a thermocurable or thermoplastic resin layer; and
c) a fibrous support, wherein a first surface of the UV resistant polymer layer forms an outermost surface of the surfacing material and the second surface of the UV resistant polymer layer contacts a first surface of the thermocurable or thermoplastic resin layer, and the second surface of the thermocurable or thermoplastic resin layer contacts a first surface of the fibrous support.

2. The surfacing material as claimed in claim 1, wherein the first surface of the UV resistant polymer layer has a Taber Abrasion resistance value of no more than 6 mg/500 cycles.

3. The surfacing material as claimed in claim 2, wherein the UV resistant polymer layer is a flexible film.

4. The surfacing material as claimed in claim 3, wherein the UV resistant polymer layer has a softening point below −40° C.

5. The surfacing material as claimed in claim 4, wherein the second surface of the UV resistant polymer layer which contacts the first surface of the thermocurable or thermoplastic resin layer has a surface energy of at least 35 dyn/cm.

6. The surfacing material as claimed in claim 5, wherein the change in the Yellowness Index of the UV resistant polymer layer is no more than 3.0 when tested according to ASTM D-4329 cycle B using a QUV weatherometer fitted with UVA 340 bulbs under a repeated cycle of 8 hours at 70° C. under UVA and 4 hours at 50° C. water condensation (no UVA) for 2000 hours total.

7. The surfacing material as claimed in claim 6, wherein the UV resistant polymer layer has a thickness of from 25 to 250 μm.

8. The surfacing material as claimed in claim 7, wherein the UV resistant polymer layer comprises a polyurethane based thermoplastic film.

9. The surfacing material as claimed in claim 8, wherein the thermocurable or thermoplastic resin layer has an areal weight of from 25 g/m2 to 200 g/m2.

10. The surfacing material as claimed in claim 9, wherein the thermocurable or thermoplastic resin layer comprises an epoxy resin.

11. The surfacing material as claimed in claim 10, wherein the fibrous support is a substantially continuous layer.

12. The surfacing material as claimed in claim 11, wherein the fibrous support is a non-woven material.

13. The surfacing material as claimed in claim 12, wherein the fibrous support has an areal density of from 25 g/m2 to 200 g/m2.

14. The surfacing material as claimed in claim 13, wherein the fibrous support has an air permeability of from 2000 l/m2s to 6000 l/m2s.

15. The surfacing material as claimed in claim 14 further comprising an electrically conductive metal mesh layer.

16. The surfacing material as claimed in claim 15 further comprising a second layer of fibrous reinforcement, said second layer of fibrous reinforcement is at least partially impregnated by a thermocurable or thermoplastic resin.

17. A method of forming a cured composite structure having an ultraviolet resistant outer surface, the method comprising:
a) depositing a surfacing material on the surface of a mould or tool with the outermost surface of the surfacing material comprising the first surface of the UV resistant polymer layer being in contact with the mould or tool surface;
b) depositing one or more layers of fibrous reinforcement onto the second surface of the surfacing material remote from the mould or tool surface, at least one of the layers of fibrous reinforcement comprising an associated layer of thermocurable or thermoplastic resin; and
c) co-curing the surfacing material and the thermocurable or thermoplastic resin of the one or more layers of fibrous reinforcement so as to form a cured composite structure.

18. A method of forming a cured composite structure having an ultraviolet resistant outer surface, the method comprising:
a) depositing a surfacing material on the surface a mould or tool with the outermost surface of the surfacing material comprising the first surface of the UV resistant polymer layer in contact with the mould or tool surface;
b) depositing one or more layers of fibrous reinforcement on to the surface of the surfacing material remote from the mould or tool surface;
c) infusing the surfacing material and the one or more layers of fibrous reinforcement with a thermocurable or thermoplastic resin to form a resin infused stack of fibrous reinforcement; and
d) co-curing the surfacing material and the thermocurable or thermoplastic resin of the resin infused stack of fibrous reinforcement so as to form a cured composite structure.

19. (canceled)

20. (canceled)

21. (canceled)

22. (canceled)

23. A surfacing material comprising:
(a) an ultraviolet (UV) resistant polymer layer;
(b) a thermocurable or thermoplastic resin layer;
(c) a fibrous support, wherein a first surface of the UV resistant polymer layer forms an outermost surface of the surfacing material and the second surface of the UV resistant polymer layer contacts a first surface of the thermocurable or thermoplastic resin layer, and the second surface of the thermocurable or thermoplastic resin layer contacts a first surface of the fibrous support; and
(d) an electrically conductive metal mesh layer contacting the second surface of the fibrous support.
